(19) United States
(12) Patent Application Publication
(10) Pub. No.: US 2006/0140102 A1
(43) Pub. Date: Jun. 29, 2006

(54) System and method for parallel selection and retrieval of data stored in a holographic data storage medium

(76) Inventors: Christophe Sigel, Broomfield, CO (US); Michael L. Leonhardt, Longmont, CO (US); William Lynch, Boulder, CO (US)

Correspondence Address: Timothy R. Schulte;Storage Technology Corporation, One StorageTek Drive, Louisville, CO, 80028-4309, US

(21) Appl. No.: 11/021,930

(22) Filed: Dec. 23, 2004

(51) Int. Cl. G11B 7/00

(52) U.S. Cl. 369/103; 369/112.01

(57) ABSTRACT

System and method for parallel selection and retrieval of data stored in an optical data storage medium. A holographic data storage medium has a plurality of data sites, each data site containing a plurality of data units recorded as multiplexed holograms. A plurality of light beams are independently controlled to illuminate a different one of the plurality of data sites for selecting and retrieving any one data unit stored at each of the plurality of data sites. The invention enables the simultaneous selection and retrieval of data units stored at a plurality of data sites of the holographic data storage medium, and permits an increase in optical data transfer rate.

### CROSS-REFERENCE TO RELATED APPLICATIONS

The present application is related to co-pending applications entitled “SYSTEM AND METHOD FOR PARALLEL SELECTIVE REPLICATION AND ANGULAR ADDRESS REMAPPING OF DATA CONTENT STORED IN A HOLOGRAPHIC DATA STORAGE MEDIUM”, Ser. No. ______, attorney docket no. 2004-067-MIS, “SYSTEM AND METHOD FOR PARALLEL SELECTIVE REPLICATION AND DATA ADDRESS REMAPPING OF DATA CONTENT STORED IN A HOLOGRAPHIC DATA STORAGE MEDIUM, Ser. No. ______, attorney docket no. 2004-074-MIS, and “SYSTEM AND METHOD FOR PROVIDING GAIN AND THRESHOLDING TO A HOLOGRAPHIC DATA PARALLEL RECORDING AND REPLICATION SYSTEM INCORPORATING INDEPENDENT ANGULAR ADDRESS ASSIGNMENT” Ser. No. ______, attorney docket no. 2004-068-MIS, all filed on even date herewith. All the above applications are assigned to the same assignee and are incorporated herein by reference.

### BACKGROUND OF THE INVENTION

1. Field of the Invention

The present invention relates generally to the field of optical data storage and, more particularly, to a system and method for parallel selection and retrieval of data stored in a holographic data storage medium.

2. Background of the Invention

Data readout from an optical recording medium is implemented by an optical pick-up head. For optical disk drives, for example, CD or DVD disk drives, the optical pick-up head conveys and focuses a single laser beam on the surface of the optical recording medium for reading data from and writing data to the optical recording medium.

The data is usually recorded on an optical disk along or between spiral or circular tracks each having a series of spatially separated marks. The length of and interval between the marks is typically used to encode the data. During readout, the focused laser beam is reflected off of the optical disk. As the disk is rotated, the reflected signal is modulated due to the difference in reflectivity from the marks to the alternating intervals between the marks; and the data is retrieved by detecting and decoding the modulated reflected signal.

In a single beam readout system, the data transfer rate can be increased by increasing the rotational speed of the disk. Data transfer rate can also be increased by reading a plurality of tracks simultaneously using a multiple beam optical pickup.

The principle of a multiple beam optical pickup consists in generating multiple beams each of which illuminates a separate data track. U.S. Pat. No. 6,449,225 proposes an exemplary scheme for multiple beam optical pickup. The disclosed system utilizes a diffraction grating in the path of a light source to split light from the light source into multiple illumination beams with angularly separated directions of propagation. The multiple illumination beams are subsequently collected and focused on multiple adjacent tracks of an optical disk.

U.S. Pat. No. 6,369,377 describes another scheme for multiple beam optical pickup which uses a combination of a polarized multiple-beam grating and a polarized holographic diffractive element. The grating splits light from a light source into multiple incident beams which are each reflected from adjacent tracks situated on the optical disk, and the reflected beams are, in turn, diffracted and deflected by the holographic diffractive element onto a photo-detector array.

Another form of optical data storage is holographic data storage. Holographic recording is achieved by illuminating a photosensitive medium with intersecting reference and object light beams. The spatial modulation of light intensity produced by interference of the beams is recorded in a holographic data storage medium by modification of the dielectric properties of the medium, either in the form of periodic spatial modulation of the refractive index of the medium or of the absorption of the medium, to constitute a grating or a hologram.

Volumetric digital page holographic storage allows a large amount of data to be recorded in parallel in the form of a 2-dimensional bit array or data page. This is accomplished by placing a spatial light modulator in the optical path of the object light beam. The spatial light modulator imparts a data page on the object light beam by modulating the spatial profile of the object beam.

Each stored data page typically comprises thousands to millions of data bits which are written and read in a single step. In a high density data storage scheme, the object beam is focused by a focusing lens within the recording medium and recorded as a volume hologram. Volumetric holographic data storage processes, commonly designated as “multiplexing”, can achieve high storage density by recording a large number of page holograms within the same area of the data storage medium. The multiplexing can be achieved by various methods, one of which is angle multiplexing, in which the angle of incidence of the reference beam is changed between successive hologram recordings. By illuminating the holographic data storage medium with an appropriate reference beam, a single associated data page stored in the data storage medium can be reconstructed.

FIG. 1 schematically illustrates a known holographic data storage and retrieval system to assist in explaining the present invention. The system is generally designated by reference number 100 and includes a single laser source 102. Light from laser source 102 is collimated by collimating lens 104 and the collimated light beam from lens 104 is split into two light beams by a polarizing beam splitter (PBS) 106.

Object beam 108 transmitted by polarizing beam splitter 106 impinges on spatial light modulator (SLM) 110, comprising a 2-Dimensional pixel array, which inscribes a data page on object beam 108 by amplitude modulation of the spatial profile of the object beam. Lens 112 focuses the modulated object beam inside holographic data storage medium 114.

Reference beam 116 reflected by PBS 106 is directed by mirrors 118 and 120 onto scanning mirror 122. Lenses 124 and 126 function as a telescope to adjust the size of the reference beam. Scanning mirror 122 deflects the reference beam which then passes through a lens system comprised of lenses 130 and 132. Lenses 130 and 132 keep the reference beam incident on the same location of holographic data storage medium 114 as object beam 108 but with a different angle of incidence determined by the deflection angle of scanning mirror 122.

As shown in FIG. 1, data is recorded in holographic data storage medium 114 as a Fourier hologram. Upon readout of a holographically stored data page by a reference beam with an appropriate angle of incidence, the spatially modulated object beam is reconstructed and collimator 140 directs and forms an image of the retrieved data page upon a 2-dimensional photodetector array 142.

A volumetric holographic data storage medium is organized into a plurality of spatially separate data sites with each data site having a plurality of superimposed data units. A data unit represents the fundamental element used to organize and record data in a physical volume element, which in the case of page-based holographic storage is a 2 dimensional array of data bits also designated as a data page. For other types of media, the data unit may be a single bit. The multiple data sites can be organized in a grid-like fashion for a cubic holographic memory; or in the case of a holographic disk, along multiple concentric tracks.

Due to the multiplexed nature of the data storage in a volumetric holographic data storage medium, an optical pick-up for a holographic disk readout system is intrinsically different from an optical pick-up for a CD or DVD because the optical pick-up for a holographic disk readout system requires additional control of the readout beam in order to achieve selective data page retrieval. In addition to a mechanism for positioning the optical pick-up adjacent to the data area to be accessed, the readout beam properties (for example, its angle of incidence) must also be configured so that it matches the hologram from which the data is to be retrieved.

Typically, holographic data storage systems, irrespective of the application and of the format of the detection medium, are based on an illumination architecture comprised of a single pair of light beams such as used in the data storage and retrieval system illustrated in FIG. 1. Despite the parallel data access capability associated with page-based holographic data storage, page-based holographic data storage systems still suffer from limitations in data transfer rate.

As described above, data transfer rate can be increased in an optical disk data storage system by reading multiple tracks simultaneously. In a page-based holographic data storage system, simultaneous readout of a plurality of data pages stored at a plurality of data sites can also provide an increase in data transfer rate.

It would, accordingly, be desirable to provide a system and method for parallel selection and retrieval of data stored in a holographic data storage medium that enables the simultaneous retrieval of data units stored at a plurality of data sites of the holographic data storage medium. Furthermore, it would be desirable to provide a system and method to enable independent selection of any one data unit among a plurality of data units stored at each data site.

### SUMMARY OF THE INVENTION

The present invention provides a system and method for parallel selection and retrieval of data stored in an optical data storage medium. A holographic data storage medium has a plurality of data sites, each data site containing a plurality of data units recorded as multiplexed holograms. A plurality of light beams are independently controlled to illuminate a different one of the plurality of data sites for selecting and retrieving any one data unit stored at each of the plurality of data sites. The invention enables the simultaneous retrieval of data units stored at a plurality of data sites of the holographic data storage medium, and permits an increase in optical data transfer rate.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 schematically illustrates a known holographic data storage and retrieval system to assist in explaining the present invention;

FIG. 2 is a schematic top view of a system for parallel selection and retrieval of data stored in a holographic data storage medium in accordance with a preferred embodiment of the present invention;

FIG. 3 is a schematic perspective view of a system for parallel selection and retrieval of data stored in a holographic data storage medium in accordance with a preferred embodiment of the present invention; and

FIG. 4 is a flowchart that illustrates a method for parallel selection and retrieval of data stored in a holographic data storage medium in accordance with a preferred embodiment of the present invention.

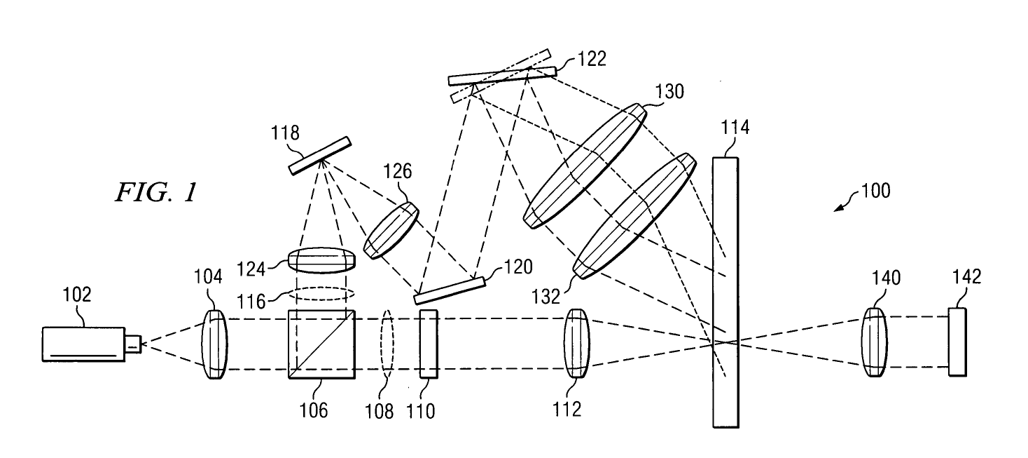

### DETAILED DESCRIPTION OF THE PREFERRED EMBODIMENT

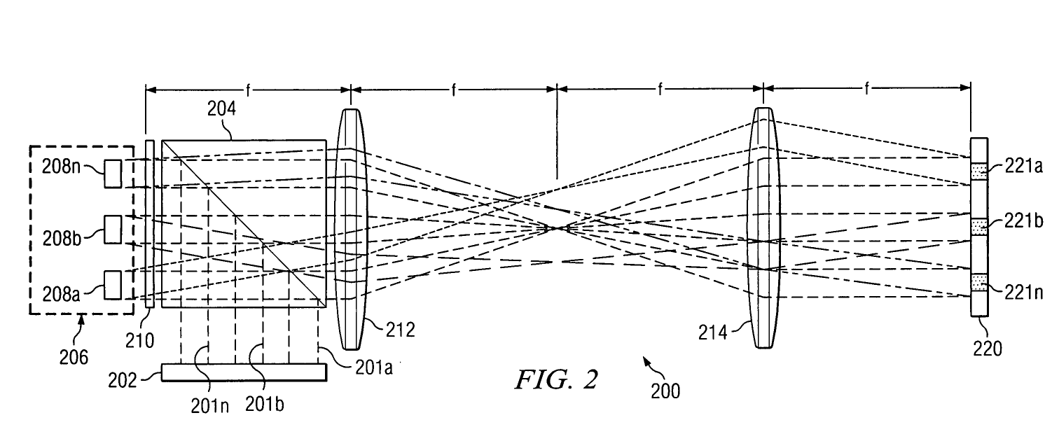

With reference to the drawings, FIG. 2 depicts a schematic top view of a system for parallel selection and retrieval of data stored in a holographic data storage medium in accordance with a preferred embodiment of the present invention. The system is generally designated by reference number 200, and includes an optical power distribution apparatus 202 for providing a plurality of linearly polarized light beams 201a-201n that define a light beam array of N light beams, for example, a 10×10 array of 100 light beams, although it should be understood that the invention is not limited to an array of any particular size or shape or to any particular number of light beams forming the array.

Optical power distribution apparatus 202 can be implemented in several ways. According to a preferred embodiment of the present invention, optical power distribution apparatus 202 can comprise one or more optical power sources and an arrangement of one or more optical couplers for coupling the output power of at least one output of the one or more optical power sources to a plurality of optical inputs forming a plurality of light beams 201a-201n. Preferably, the one or more optical couplers are tunable fiber-optic couplers, which allow adjustment of the coupling ratio of the optical power to each one of multiple fiber outputs (or respective fiber inputs of the multi-beam array). If the tunable couplers have a tuning range down to a virtually zero output level, redistribution of the available optical power among any of the up to N multiple inputs is permitted based on the number of required inputs among the N available inputs. Co-pending application entitled “OPTICAL POWER DISTRIBUTION MANAGEMENT AND APPARATUS”, Ser. No. 10/749,427, attorney docket no. 2003-074-DSK, filed on Dec. 31, 2003, assigned to the same assignee as the present invention and incorporated herein by reference, discloses a preferred implementation for delivering optical power to multiple optical inputs.

Returning to FIG. 2, the plurality of linearly polarized input beams 201a-201n, only three of which are illustrated in FIG. 2, are reflected by polarizing beam splitter (PBS) 204 onto a reflective or transmissive multi-element spatial light modulator 206. Spatial light modulator (SLM) 206 comprises an array of at least N elements which are individually addressable. In the preferred embodiment illustrated in FIG. 2, SLM 206 is implemented by a micro-electro-mechanical system (MEMS) fabricated micro-mirror array. Individual light beams 201a-201n are incident, respectively, on micromirrors 208a-208n which independently deflect the N individual light beams 201a-201n in the plane constituted by the optical axis of the optical system and the array of input light beams, thus creating a plurality of reflected reference light beams with individual deflection angles.

When using a reflective SLM, a quarter wave plate 210 oriented at 45 degrees with respect to the direction of polarization of the plurality of input light beams is placed between PBS 204 and SLM 206. Quarter wave plate 210 transforms the incident linear polarized beams 201a-201n into circular polarized beams, the handedness of the circular polarization depending on the relative orientation of incident polarization with respect to the fast axis of quarter wave plate 210, whereas the effect of the reflective elements of SLM 206 is to change the handedness of the circular polarization. The backward propagating beams deflected by SLM 206 are thus circularly polarized with the opposite handedness, and are thus transformed by quarter wave plate 210 into linear polarized beams, but with orthogonal polarization with respect to the direction of linear polarization of the incident beams. The deflected backward-propagating light beams are then transmitted through PBS 204.

According to an alternative embodiment of the present invention, SLM 206 can be implemented as a liquid crystal spatial light modulator (LC-SLM). An LC-SLM comprises a rectangular array of P×Q individually controllable pixels, which can be organized into N regions comprising P×Q/N pixels. In a suitable configuration, each pixel can impart a controllable relative phase to the light incident thereupon. The individual pixels forming each region can be configured to form a reconfigurable phase grating, which diffracts incident light. Changing the periodicity of the phase diffraction grating results in a change in the deflection angle imparted to an individual beam. In this manner, the N individual input beams can be individually deflected by the SLM based on a liquid crystal array in a manner equivalent to a MEMS-based mirror array. An LC-SLM can be used both in a reflective configuration or a transmissive configuration.

According to the preferred embodiment of FIG. 2, MEMS micro-mirror array 208a-208n is imaged onto holographic data storage medium 220 by a 2-lens 4-f system comprising lenses 212 and 214. The lenses 212 and 214 are of equal focal length and positioned such that the image focal plane of lens 212 coincides with the object focal plane of lens 214 to form a negative unity magnification telescope. MEMS mirror array 208a-208n is positioned in the object plane of lens 212, and holographic data storage medium 220 is positioned in the image plane of lens 214, such that the image of each individual mirror 208a-208n of the MEMS micro-mirror array coincides with an individual data storage site 221a-221n in holographic data storage medium 220. The effect of the 4-f system is to maintain the respective positions of incidence of the individual beams coincident with the individual data storage sites 221a-221n of holographic data storage medium 220, with the variable angles of incidence opposite to the individual reflection angles imparted by corresponding micro-mirrors 208a-208n. The 4-f imaging system is independent of the particular type of SLM, and thus is applicable to alternative embodiments employing either a transmissive or reflective SLM.

System 200 provides a mechanism for independently varying the angles of incidence of the individual light beams that illuminate the plurality of data sites 221a-221n in holographic data storage medium 220; and, accordingly, is suitable for the parallel readout of a plurality of angle multiplexed data pages or units stored at the plurality of data sites. By controlling the angles of incidence of the plurality of light beams at each data site, system 200 further includes the capability of independently selecting and retrieving any data unit among the plurality of angle multiplexed data units recorded at each data site of data storage medium 200. By controlling the number of light beams to which optical power is distributed among the plurality of available light beams, each light beam illuminating a different one of the plurality of data sites, system 200 further includes the capability of selectively accessing only the data sites among the plurality of accessible data sites which contain data to be retrieved.

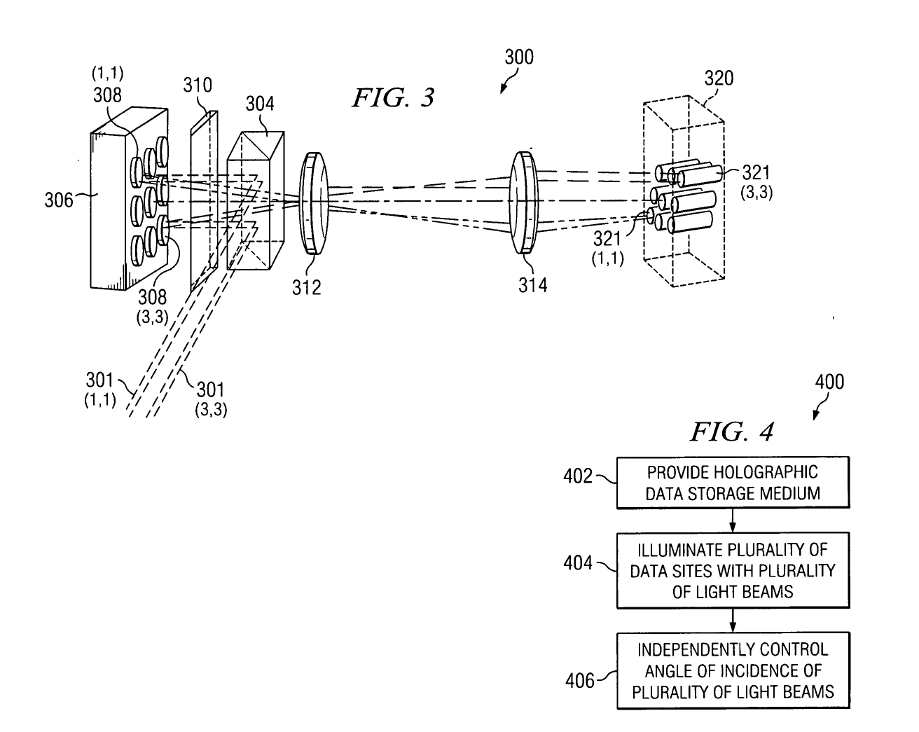

FIG. 3 is a schematic perspective view of a system for parallel selection and retrieval of data stored in a holographic data storage medium in accordance with a preferred embodiment of the present invention. The system is generally designated by reference number 300 and comprises a three-dimensional representation of system 200 illustrated in FIG. 2. A plurality of input linearly polarized light beams 301 (i,j) are positioned in a two-dimensional lattice-like arrangement. The indices i and j respectively represent the row and column position corresponding to a given light beam. Only two beams 301(1,1) and 301(3,3) are illustrated in FIG. 3 for purposes of clarity. After being reflected by PBS 304 and after being transmitted through quarter wave plate 310, each individual beam 301(i,j) is reflected by corresponding micro-mirror 308(i,j) of SLM 306 and subsequently transmitted back through PBS 304 and imaged by lenses 312 and 314 such that the light beams are centered on data site locations 321(i,j) on the surface of holographic data storage medium 320. The size of the individual input beams and of the individual micro-mirrors is such that the individual beams maintain overlap over the entire volume occupied by the individual data sites 321(i,j) in holographic data storage medium 320 over the entire range of incident angles.

FIG. 4 is a flowchart that illustrates a method for parallel selection and retrieval of data stored in a holographic data storage medium in accordance with a preferred embodiment of the present invention. The method is generally designated by reference number 400 and begins by providing a holographic data storage medium that has a plurality of data sites, each of the plurality of data sites holographically storing a plurality of angle multiplexed data units (Step 402). Each of at least one of the plurality of data sites containing at least one data unit to be retrieved is illuminated with a different one of a plurality of light beams (Step 404), and the angle of incidence of each of the plurality of light beams with respect to the holographic data storage medium is independently controlled to retrieve a selected one of the plurality of angle multiplexed data units stored at each of the plurality of data sites (Step 406).

The present invention thus provides a system and method for parallel selection and retrieval of data stored in a holographic data storage medium, for example, an angularly multiplexed holographic data storage medium. The angularly multiplexed holographic data storage medium preferably has a plurality of data sites, each data site holographically storing at least one data unit with at least one of a plurality of different angular addresses. Each of a plurality of light beams illuminate, with any one of a plurality of angles of incidence, a different one of the plurality of data sites for retrieving any one of the at least one data unit stored at each of the plurality of data sites. The invention enables the simultaneous independent selection and retrieval of data units stored at a plurality of data sites of a holographic data storage medium, and permits an increase in optical data transfer rate. The invention also includes the capability of selectively accessing only the data sites among a plurality of accessible data sites which contains data to be retrieved. However the invention is not restricted to providing simultaneous access to multiple data sites of a holographic data storage medium. The invention can also be used for accessing multiple data sites of any optical data storage medium, for example by providing access to multiple tracks of an optical disk. The additional capability of control of the incident angle makes it compatible with any angular multiplexing technique employed for the recording or readout of data.

The invention also provides a method for simultaneous multi-beam illumination of multiple locations on the surface of a medium, and/or within the medium. The invention can be used to simultaneously illuminate an optical medium with spatially separate beams which enables parallel optical processing. Other applications of the invention include:—an illumination system for multiple beam photolithography on a medium;—an illumination system for machine vision systems, to perform large surface inspection of a medium, where the medium can include semiconductor wafers, printed circuit boards, or any type of medium or packaging which requires inspection through optical means;—an illumination system for detail profilometry of a physical surface or feature of a medium.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for parallel selection and retrieval of data stored in a holographic data storage medium, comprising:
providing a holographic data storage medium having a plurality of data sites, each of the plurality of data sites capable of holographically storing at least one data unit; and
illuminating each of at least one of the plurality of data sites with a different one of a plurality of light beams for retrieving the at least one data unit stored at each of the plurality of data sites.

2. The method according to claim 1, wherein illuminating each of at least one of the plurality of data sites with a different one of a plurality of light beams for retrieving the at least one data unit stored at each of the plurality of data sites comprises:
providing a plurality of light beams; and
imaging each of the plurality of light beams on a different one of the plurality of data sites.

3. The method according to claim 2, wherein imaging each of the plurality of light beams on a different one of the plurality of data sites comprises:
directing each of the plurality of light beams onto a different one of a plurality of regions, each comprising at least one of a plurality of independent modulating elements, that form a multi-element spatial light modulator; and
forming, by an imaging system, an image of each one of the plurality of regions onto a different one of the plurality of data sites.

4. The method according to claim 2, and further including:
separately controlling an angle of incidence of each of the plurality of light beams with respect to the holographic data storage medium.

5. The method according to claim 4, wherein each of the plurality of light beams is incident on a different one of a plurality of regions, each region comprising at least one modulating element of a plurality of independent modulating elements, and wherein separately controlling an angle of incidence of each of the plurality of light beams with respect to the holographic data storage medium comprises:
separately modulating each of the plurality of light beams incident on a different one of the plurality of regions with a different modulation pattern formed by the at least one modulating element comprising each region.

6. The method according to claim 3, wherein the spatial light modulator is a reflective spatial light modulator comprising a plurality of independent reflective elements, wherein each region comprises a single reflective element, and wherein the method further includes separately controlling a tilt angle of each of the plurality of reflective elements with respect to a direction of incidence of the plurality of light beams.

7. The method according to claim 2, wherein each of the plurality of data sites has a plurality of data units holographically stored therein, wherein each data unit stored at each data site has an angular address, and wherein the method further includes:
controlling each of the plurality of light beams to retrieve a selected data unit stored at each of at least one of the plurality of data sites by independently controlling the angle of incidence of each of the plurality of light beams with respect to the holographic data storage medium

8. The method according to claim 1, wherein the holographic data storage medium contains a plurality of selected data units to be retrieved among the plurality of data units contained in the holographic data storage medium, and wherein illuminating each of at least one of the plurality of data sites with a different one of a plurality of light beams for retrieving the at least one data unit stored at each of the plurality of data sites comprises simultaneously illuminating only at least one data site of the plurality of data sites that store at least one selected data unit to be retrieved.

9. A system for parallel selection and retrieval of data stored in a holographic data storage medium, comprising:
a holographic data storage medium having a plurality of data sites, each of the plurality of data sites capable of holographically storing at least one data unit;
a multiple beam controller and illumination apparatus for separately controlling each of at least one of a plurality of light beams to provide illumination to a different one of at least one of the plurality of data sites for separately selecting and retrieving any one of the at least one data unit holographically stored at each of the at least one of the plurality of data sites; and
an optical power distribution apparatus for distributing optical power from at least one light source to a plurality of optical inputs forming a plurality of input light beams.

10. The system according to claim 9, wherein the plurality of light beams comprise a plurality of linearly polarized light beams, and wherein the multiple beam controller and illumination apparatus comprises:
a polarization beam splitter for simultaneously reflecting the plurality of linearly polarized light beams;
a quarter wave plate, oriented at one of plus forty-five degrees and minus forty-five degrees with respect to a direction of polarization of the linearly polarized light beams for transforming the linearly polarized light beams into a plurality of one of transmitted right-handed and left-handed circularly polarized beams;
a spatial light modulator, the plurality of circularly polarized light beams being incident upon the spatial light modulator; and
an imaging system for forming an image of each of the plurality of circularly polarized light beams onto a different one of the plurality of data sites.

11. The system according to claim 10, wherein the spatial light modulator comprises one of a transmissive spatial light modulator and a reflective spatial light modulator.

12. The system according to claim 11, wherein the spatial light modulator comprises one of a micro-electro-mechanical system mirror array reflective modulator and a liquid crystal phase modulator.

13. The system according to claim 10, wherein the spatial light modulator independently controls an angle of incidence of each of the plurality of circularly polarized light beams with respect to the holographic data storage medium.

14. The system according to claim 13, wherein a plurality of data units are stored at each of the plurality of data sites, wherein each of the plurality of data units is associated with a different one of a plurality of angular addresses, and wherein the spatial light modulator controls the angle of incidence of each of the plurality of circularly polarized light beams to simultaneously retrieve a selected data unit from the plurality of data units stored at each of at least one of the plurality of data sites.

15. A method for multiple beam illumination of a medium, comprising:
providing a plurality of light beams;
independently controlling the plurality of light beams to illuminate a plurality of locations on a medium; and
distributing optical power from at least one light source to a plurality of optical power inputs forming the plurality of light beams.

16. The method according to claim 15, wherein independently controlling the plurality of light beams to illuminate a plurality of locations on a medium comprises:
independently controlling an angle of incidence of the plurality of light beams on the medium.

17. The method according to claim 15, wherein distributing optical power from at least one light source to a plurality of optical power inputs forming the plurality of light beams comprises:
coupling optical power from at least one light source to a plurality of optical power inputs forming a plurality of linearly polarized light beams.

18. The method according to claim 17, wherein independently controlling the plurality of light beams to illuminate a plurality of locations on a medium comprises:
independently deflecting each of the plurality of light beams with a spatial light modulator;
controlling polarization of the plurality of light beams incident on the spatial light modulator; and
imaging the plurality of light beams incident on the spatial light modulator onto a plurality of locations on the medium.
